(19) United States
(12) Patent Application Publication
(10) Pub. No.: US 2024/0113368 A1
(43) Pub. Date: Apr. 4, 2024

(54) METHOD FOR PRODUCING POWER STORAGE DEVICE AND POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/464,265

(22) Filed: Sep. 11, 2023

(30) Foreign Application Priority Data
Oct. 4, 2022 (JP) 2022-160189

(51) Int. Cl. H01M 50/176; H01M 50/103; H01M 50/15; H01M 50/169; H01M 50/188; H01M 50/193

(52) U.S. Cl. CPC H01M 50/176; H01M 50/103; H01M 50/15; H01M 50/169; H01M 50/188; H01M 50/193

(57) ABSTRACT

A method for producing a power storage device includes closing an opening portion of a case body with a lid of a lid assembly, and laser-welding the opening portion of the case body and a peripheral portion of the lid over their entire circumference. A resin member has an outer surface including a scattered light-reached surface to which scattered light of a laser beam directly reaches, at least a part of the scattered light-reached surface including a smoothed region having a surface roughness of 0.6 μm or less.

### CROSS-REFERENCE TO RELATED APPLICATIONS

This application is based upon and claims the benefit of priority to Japanese Patent Application No. 2022-160189 filed on Oct. 4, 2022, the entire contents of which are incorporated herein by reference.

### BACKGROUND

### Technical Field

The present disclosure relates to a method for producing a power storage device, such as a battery or a capacitor, in which a terminal member is fixed to a case via a resin member, and a power storage device.

### RELATED ART

As a power storage device, there is known a rectangular battery in which positive and negative terminal members are each fixed to a case having a rectangular parallelepiped box-like shape with a resin member placed therebetween. Specifically, the case is composed of: a bottomed rectangular tube-shaped case body having a rectangular ring-shaped opening portion; and a rectangular plate-shaped lid which is laser-welded to the case body over the entire circumference to close the opening portion. In addition, the positive and negative terminal members are inserted individually in a pair of insertion holes formed in the lid and extend from the inside to the outside of the case. A pair of resin members are joined to the lid and also joined to the positive and negative terminal members while insulating between the lid and the terminal members. One example of the conventional art is disclosed in Japanese unexamined patent application publication No. 2021-086813 (see FIGS. 1 and 2, etc., of this publication No. 2021-086813).

### SUMMARY

### Technical Problems

However, in such a battery production process, when the opening portion of the case body is closed with the lid to which the terminal members are fixed in advance, and the opening portion of the case body and a peripheral portion of the lid are laser-welded over the entire circumference, scattered light of a laser beam may directly reach the outer surfaces of the resin members, which insulate between the lid and the terminal members. This scattered light may form scorched or burn portions on a part of the outer surfaces, to which the scattered light directly reaches, which will be referred to as a scattered light-reached surface.

The present disclosure has been made in view of such circumstances, and provides a method for producing a power storage device, and the power storage device produced by this method, in which when a case body and a lid are welded by a laser to form a case, of an outer surface of a resin member insulating between the lid and a terminal member, a scattered light-reached surface to which scattered light of a laser beam directly reaches can be prevented from formation of a scorched portion.

### Means of Solving the Problems

(1) To achieve the above problems, one aspect of the present disclosure provides a method for producing a power storage device, the power storage device including: a case including a bottomed tube-shaped case body having an opening portion, and a lid that is laser-welded to the case body over an entire circumference and closes the opening portion; a terminal member inserted in an insertion hole that penetrates through the lid in a lid thickness direction; and a resin member joined to the terminal member and joined to an insertion-hole surrounding portion of the lid, which surrounds the insertion hole, while insulating between the terminal member and the insertion-hole surrounding portion of the lid, wherein the method comprises: closing the opening portion of the case body with the lid of a lid assembly in which the terminal member is integrated with the lid via the resin member; and laser-welding the opening portion of the case body and a peripheral portion of the lid over the entire circumference to form the case by irradiating a laser beam to the opening portion of the case body and the peripheral portion of the lid, and wherein the resin member has an outer surface exposed on an outside of the case, the outer surface including a scattered light-reached surface to which scattered light, which is radiated from an irradiated portion applied with the laser beam, of the opening portion of the case body and the peripheral portion of the lid, directly reaches, and at least a part of the scattered light-reached surface including a smoothed region having a surface roughness Ra of 0.6 μm or less.

The above-described method for producing the power storage device uses the lid assembly including the resin member in which at least a part of the scattered light-reached surface of the outer surface is the smoothed region having a surface roughness Ra of 0.6 μm or less. Accordingly, in the laser-welding process, even if the scattered light of the laser beam directly reaches the smoothed region, the scattered light is likely to be reflected by the smoothed region, and is less likely to be absorbed by the resin member. Thus, the smoothed region is unlikely formed with a scorched or burn portion, which prevents formation of a scorched portion on the scattered light-reached surface.

The smoothed region of the outer surface of the resin member only needs to be at least a part of the scattered light-reached surface, and thus it may be only a part of the scattered light-reached surface, may be the entire scattered light-reached surface, or even may be the entire outer surface including the scattered light-reached surface. The surface roughness Ra of the smoothed region may be 0.3 μm or less and further 0.1 μm or less. This is because the scattered light of the laser beam is further likely to be reflected by the smoothed region, and the scorched portion is further less likely to be formed on the smoothed region.

A method for making the surface roughness Ra of the outer surface of the resin member, such as the scattered light-reached surface, to be 0.6 μm or less may be selected from the following methods:
(1) mirror-finishing a surface-forming face for forming the outer surface of the resin member, of a mold for molding the resin member;
(2) polishing the outer surface of the resin member;
(3) treating the outer surface of the resin member with a chemical agent;
(4) applying infrared rays to the outer surface of the resin member to melt the surface; and
(5) pressing a hot plate against the outer surface of the resin member to melt the surface.

The surface roughness Ra of the outer surface of the resin member can be measured with a known contact-type roughness meter. The surface roughness Ra can also be measured with a known non-contact-type roughness meter.

The power storage device may include for example a secondary battery such as a lithium-ion secondary battery, a capacitor such as a lithium-ion capacitor, and an all-solid-state battery.

(2) Furthermore, the above-described method for producing the power storage device described in (1) may further comprise, before closing the opening portion of the case body, forming the lid assembly by insert-molding the resin member in a state where the terminal member is inserted in the insertion hole of the lid, wherein in forming the lid assembly, the resin member including the smoothed region is molded by using a mold in which a surface-forming face for forming the outer surface of the resin member includes a smoothed-region forming face for forming the smoothed region, the smoothed-region forming face being mirror-finished.

In the above-described method for producing the power storage device, in the lid assembly forming process, the resin member having the smoothed region is molded by using the above-described mold in which the smoothed-region forming face of the surface-forming face is mirror-finished in advance. Therefore, at the same time as molding the resin member, the smoothed region can be formed on the outer surface of the resin member.

(3) Further, in the above-described method for producing the power storage device described in (1), the outer surface of the resin member may be formed entirely as the smoothed region.

In the above-described method for producing the power storage device, the entire outer surface of the resin member is formed as the smoothed region having a surface roughness Ra of 0.6 μm or less. Accordingly, any portion of the outer surface of the resin member is likely to reflect the scattered light of the laser beam, suppressing formation of the scorched portion thereon.

(4) Furthermore, the above-described method for producing the power storage device described in (3) may further comprise, before closing the opening portion of the case body, forming the lid assembly by insert-molding the resin member in a state where the terminal member is inserted in the insertion hole of the lid, wherein in forming the lid assembly, the resin member having the outer surface entirely formed as the smoothed region is molded by using a mold in which a surface-forming face for forming the outer surface of the resin member is entirely mirror-finished.

In the above-described method for producing the power storage device, in the lid assembly forming process, the resin member is molded to have the entire outer surface formed as the smoothed region by using the above-described mold in which the entire surface-forming face is mirror-finished. Therefore, at the same time as molding the resin member, the smoothed region can be formed on the entire outer surface of the resin member.

(5) Another aspect provides a power storage device comprising: a case including a bottomed tube-shaped case body having an opening portion, and a lid that is laser-welded to the case body over an entire circumference and closes the opening portion; a terminal member inserted in an insertion hole that penetrates through the lid in a lid thickness direction; and a resin member joined to the terminal member and joined to an insertion-hole surrounding portion of the lid, which surrounds the insertion hole, while insulating between the terminal member and the insertion-hole surrounding portion of the lid, wherein the resin member has an outer surface exposed on an outside of the case, the outer surface including a scattered light-reached surface to which scattered light, which is radiated from an irradiated portion applied with the laser beam, of the opening portion of the case body and the peripheral portion of the lid, directly reaches, and at least a part of the scattered light-reached surface including a smoothed region having a surface roughness Ra of 0.6 μm or less.

In the above-described power storage device, in the outer surface of the resin member, at least a part of the scattered light-reached surface is the smoothed region. This configuration can suppress a scorched portion from forming on the scattered light-reached surface of the resin member, allowing the resin member to keep its original appearance and preventing a decrease in the insulation resistance between the lid and the terminal member through a formed scorched portion.

(6) In the power storage device described in (5), furthermore, the outer surface of the resin member entirely may include the smoothed region. In the above-described power storage device, the entire outer surface of the resin member is the smoothed region. This configuration can suppress a scorched portion from forming on the entire outer surface of the resin member, allowing the resin member to keep its original appearance and preventing a decrease in the insulation resistance between the lid and the terminal member through a formed scorched portion.

### BRIEF DESCRIPTION OF THE DRAWINGS

FIG. 1 is a perspective view of a battery in an embodiment;

FIG. 2 is a cross-sectional view of the battery in the embodiment taken along a battery height direction and a battery width direction;

FIG. 3A is a partially enlarged cross-sectional view of an area around an opening portion of a case body and a peripheral portion of a lid of the battery in the embodiment, taken along the battery height direction and the battery width direction;

FIG. 3B is a partially enlarged cross-sectional view of the area around the opening portion of the case body and the peripheral portion of the lid of the battery in the embodiment, taken along the battery height direction and a battery thickness direction;

FIG. 4 is a flowchart showing a method for producing the battery in the embodiment;

FIG. 5 is a view related to the method for producing the battery in the embodiment, illustrating a lid assembly formed in a lid assembly forming step;

FIGS. 6A and 6B are views related to the method for producing the battery in the embodiment, showing that molten resin is injected into a mold in the lid assembly forming step, and respectively illustrating a partially enlarged cross-section taken along the battery height direction and the battery width direction, and a partially enlarged cross-section taken along the battery height direction and the battery thickness direction;

FIG. 7 is a view related to the method for producing the battery in the embodiment, showing that the opening portion of the case body is closed with the lid included in the lid assembly in a closing step; and

FIGS. 8A and 8B are views related to the method for producing the battery in the embodiment, showing that the opening portion (a long-side opening portion) of the case body and the peripheral portion (a long-side peripheral portion) of the lid are laser-welded in a welding step, and respectively showing that irradiation of a laser beam is started and that a molten metal portion is formed by irradiation of the laser beam.

### DETAILED DESCRIPTION OF THE EXEMPLARY EMBODIMENTS

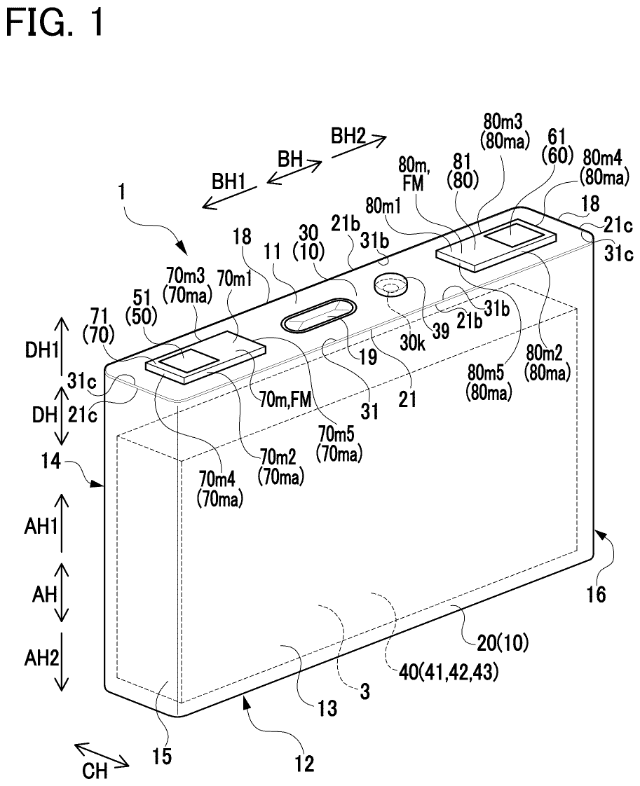

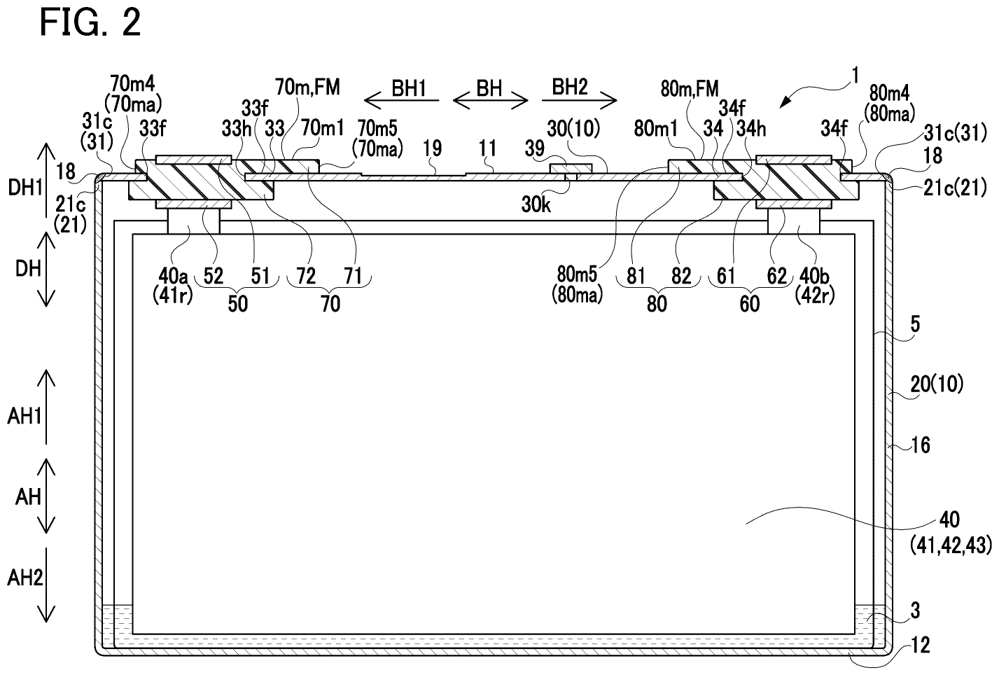

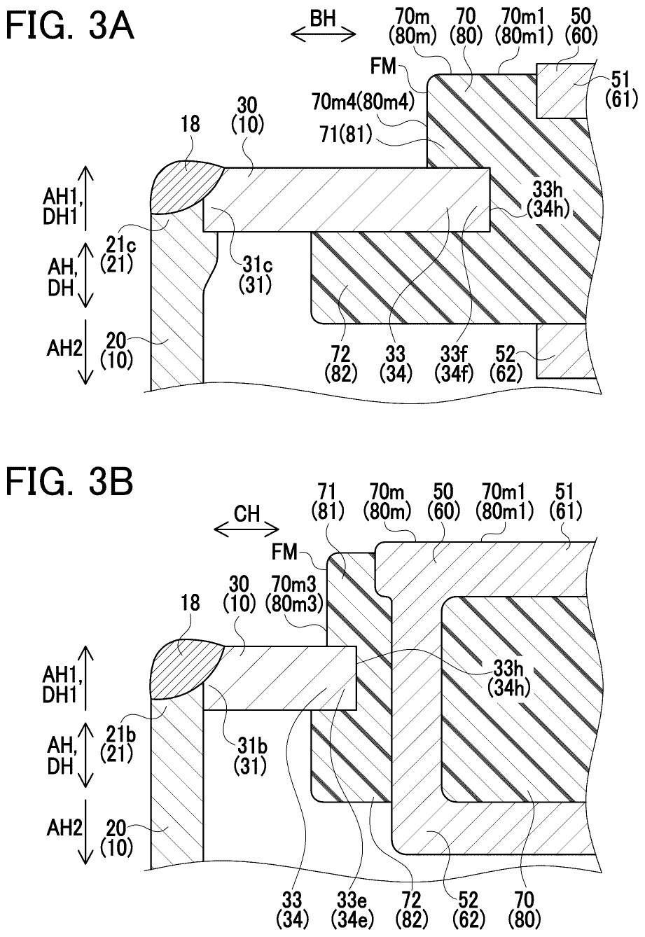

Hereinafter, an embodiment of the present disclosure will be described with reference to the drawings. FIG. 1 is a perspective view of a battery (one example of a power storage device of the present disclosure) 1 in the present embodiment. FIG. 2 is a cross-sectional view of the whole battery 1. FIGS. 3A and 3B are partially enlarged cross-sectional views of an area around an opening portion 21 of a case body 20 and a peripheral portion 31 of a lid 30 of the battery 1. The following description will be given with a battery height direction AH, a battery width direction BH, and a battery thickness direction CH of the battery 1 being defined as directions shown in FIGS. 1 to 3B. The battery 1 is a rectangular (rectangular parallelepiped-shaped) sealed lithium-ion secondary battery, which will be mounted in a vehicle, such as a hybrid car, a plug-in hybrid car, or an electric car.

The battery 1 includes a case 10, an electrode body 40 housed in the case 10, a positive terminal member 50 and a negative terminal member 60 each supported on a case top part 11 of the case 10 via resin members 70 and 80 and others. In the case 10, the electrode body 40 is covered with a bag-shaped insulating holder 5 made of an insulating film, which is open on an upper side AH1 in the battery height direction AH. In addition, the case 10 contains an electrolyte 3, a part of which is impregnated in the electrode body 40 and the rest is accumulated on a case bottom part 12 of the case 10.

The case 10 is made of a metal (aluminum in the present embodiment) in a rectangular parallelepiped box-like shape, and includes the rectangular case top part 11 located on the upper side AH1 in the battery height direction AH, the rectangular case bottom part 12 opposed to the case top part 11 and located on a lower side AH2 in the battery height direction AH, and four rectangular case side wall parts (a pair of case long-side parts 13 and 14 and a pair of case short-side parts 15 and 16) connecting the top part 11 and bottom part 12.

The case 10 includes the case body 20 and the lid 30. The case body has a bottomed rectangular tube shape having the rectangular ring-shaped opening portion 21 on the upper side AH1 in the battery height direction AH, and forms the case bottom part 12, the case long-side parts 13 and 14, and the case short-side parts 15 and 16 of the case 10. Meanwhile, the lid 30 has a rectangular plate shape and forms the case top part 11 of the case 10. The lid is laser-welded to the case body 20 over the entire circumference to close the opening portion 21 of the case body 20, and accordingly a melt-solidified portion 18 is formed between the lid 30 and the case body 20. Specifically, a pair of long-side opening portions 21b of the rectangular ring-shaped opening portion 21 of the case body 20 and a pair of long-side peripheral portions 31b of the rectangular ring-shaped peripheral portion 31 of the lid 30 are welded to each other to form the melt-solidified portion 18 (see FIG. 3B). Also, a pair of short-side opening portions 21c of the opening portion 21 of the case body 20 and a pair of short-side peripheral portions 31c of the peripheral portion 31 of the lid are welded to each other to form the melt-solidified portion 18 (see FIG. 3A).

The lid 30 is provided with a safety valve 19 which breaks and opens when the internal pressure of the case 10 exceeds a valve opening pressure. The lid 30 also has a liquid inlet 30k formed so as to communicate between the inside and the outside of the case 10, and the liquid inlet 30k is hermetically sealed with a disc-shaped sealing member 39 made of aluminum. The lid 30 is provided with rectangular insertion holes 33h and 34h, which are located near an end portion on one side BH1 and near an end portion on the other side BH2 in the battery width direction BH, respectively, and penetrate in a lid thickness direction DH. The positive terminal member 50 made of aluminum is inserted in the insertion hole 33h and fixed to the lid 30 via the resin member 70 so that the terminal member 50 is insulated from the lid 30. In addition, the negative terminal member 60 made of copper is inserted in the other insertion hole 34h and fixed to the lid 30 via the resin member 80 so that the terminal member 60 is insulated from the lid 30.

These terminal members 50 and 60 respectively have rectangular plate-shaped outer terminal portions 51 and 61 placed on the lid 30, and inner terminal portions 52 and 62 placed mainly inside the case 10 and continuous to the outer terminal portions 51 and 61 through the insides of the insertion holes 33h and 34h of the lid 30. The positive inner terminal portion 52 is joined and electrically conductive to a positive electrode tab 40a of the electrode body 40 in the case 10. Meanwhile, the negative inner terminal portion 62 is joined and electrically conductive to a negative electrode tab 40b of the electrode body 40 in the case 10.

The resin member 70 is joined to the positive terminal member 50 and a rectangular ring-shaped insertion-hole surrounding portion 33, which surrounds the insertion hole 33h of the lid 30 and which has a pair of long-side surrounding portions 33e and a pair of short-side surrounding portions 33f. The resin member 70 insulates between the insertion-hole surrounding portion 33 of the lid and the positive terminal member 50. Similarly, the resin member 80 is joined to the negative terminal member 60 and a rectangular ring-shaped insertion-hole surrounding portion 34, which surrounds the insertion hole 34h of the lid 30 and which has a pair of long-side surrounding portions 34e and a pair of short-side surrounding portions 34f. The resin member 80 insulates between the insertion-hole surrounding portion 34 of the lid 30 and the negative terminal member 60.

These resin members 70 and 80 are made of polyphenylene sulfide (PPS), and respectively have rectangular plate-shaped outer insulating portions 71 and 81 placed on the lid 30, and inner insulating portions 72 and 82 placed inside the case 10 and in the insertion holes 33h and 34h of the lid 30 and continuous to the outer insulating portions 71 and 81. The outer insulating portions 71 and 81 insulate between the outer terminal portions 51 and 61 of the terminal members 50 and 60 and the insertion-hole surrounding portions 33 and 34 of the lid 30, respectively. Meanwhile, the inner insulating portions 72 and 82 insulate between the inner terminal portions 52 and 62 of the terminal members 50 and 60 and the insertion-hole surrounding portions 33 and 34 of the lid 30, respectively.

In the resin member 70, an outer surface 70m exposed on the outside of the case 10 has a first outer surface 70m1 facing the upper side AH1 in the battery height direction AH, a second outer surface 70m2 and a third outer surface 70m3 facing in the battery thickness direction CH, a fourth outer surface 70m4 facing the one side BH1 in the battery width direction BH, and a fifth outer surface 70m5 facing the other side BH2 in the battery width direction BH. In addition, in the resin member 80, an outer surface 80m exposed on the outside of the case 10 has a first outer surface 80m1 facing the upper side AH1 in the battery height direction AH, a second outer surface 80m2 and a third outer surface 80m3 facing the battery thickness direction CH, a fourth outer surface 80m4 facing the other side BH2 in the battery width direction BH, and a fifth outer surface 80m5 facing the one side BH1 in the battery width direction BH.

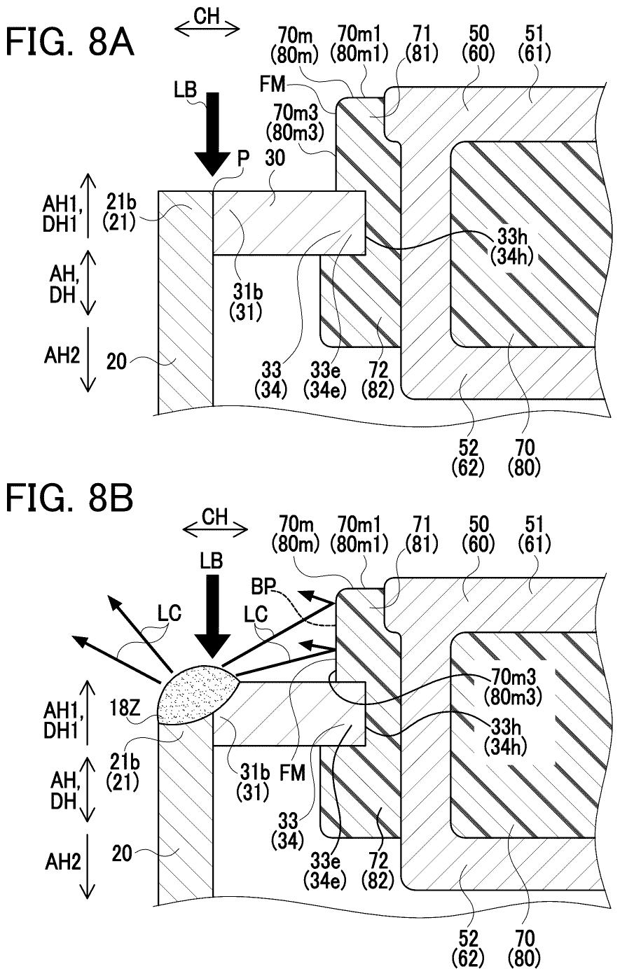

In the resin members 70 and 80 of the present embodiment, the portions of the outer surfaces 70m and 80m excluding the first outer surfaces 70m1 and 80m1, that is, the second outer surfaces 70m2 and 80m2, the third outer surfaces 70m3 and 80m3, the fourth outer surfaces 70m4 and 80m4, and the fifth outer surfaces 70m5 and 80m5, are scattered light-reached surfaces 70ma and 80ma. These scattered light-reached surfaces 70ma and 80ma are portions to which scattered light LC radiated from irradiated portions P of the opening portion 21 of the case body 20 and the peripheral portion 31 of the lid 30 applied with a laser beam LB, directly reaches, as described later. In the resin members 70 and 80 of the present embodiment, the outer surfaces 70m and 80m including the entire scattered light-reached surfaces 70ma and 80ma are each formed entirely as a smoothed region FM having a surface roughness Ra of 0.6 μm or less (specifically, 0.1 μm). This configuration can prevent formation of a scorched portion BP (see FIG. 8B) on the entire outer surfaces 70m and 80m.

The electrode body 40 is a laminated electrode body having a flat, rectangular parallelepiped box-like shape, in which a plurality of positive electrode plates 41 and a plurality of negative electrode plates 42, each having a rectangular shape and extending in the battery height direction AH and the battery width direction BH, are alternately stacked in the battery thickness direction CH with separators 43 composed of a porous resin membrane interposed therebetween. Each of the positive electrode plates 41 has a positive current collecting portion 41r extending upward on the upper side AH1, and the respective positive current collecting portions 41r overlap each other in the thickness direction thereof to form the above-described positive electrode tab 40a. The positive electrode tab 40a is connected to the inner terminal portion 52 of the positive terminal member 50 as described above. In addition, each of the negative electrode plates 42 has a negative current collecting portion 42r extending upward on the upper side AH1, and the respective negative current collecting portions 42r overlap each other in the thickness direction thereof to form the above-described negative electrode tab 40b. The negative electrode tab 40b is connected to the inner terminal portion 62 of the negative terminal member 60 as described above.

In the resin members 70 and 80 of the battery 1 of the present embodiment, the entire outer surfaces 70m and 80m, including the scattered light-reached surfaces 70ma and 80ma, are each the smoothed region FM having a surface roughness Ra of 0.6 μm or less. This can prevent formation of the scorched portion BP on the entire outer surfaces 70m and 80m of the resin members 70 and 80, maintaining the original appearance of the resin members 70 and 80, and preventing a decrease in the insulation resistance between the lid and the terminal members 50 and 60 through a formed scorched portion BP.

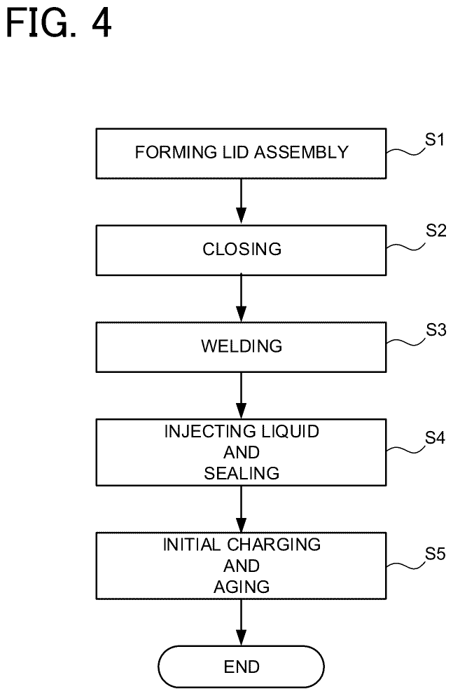

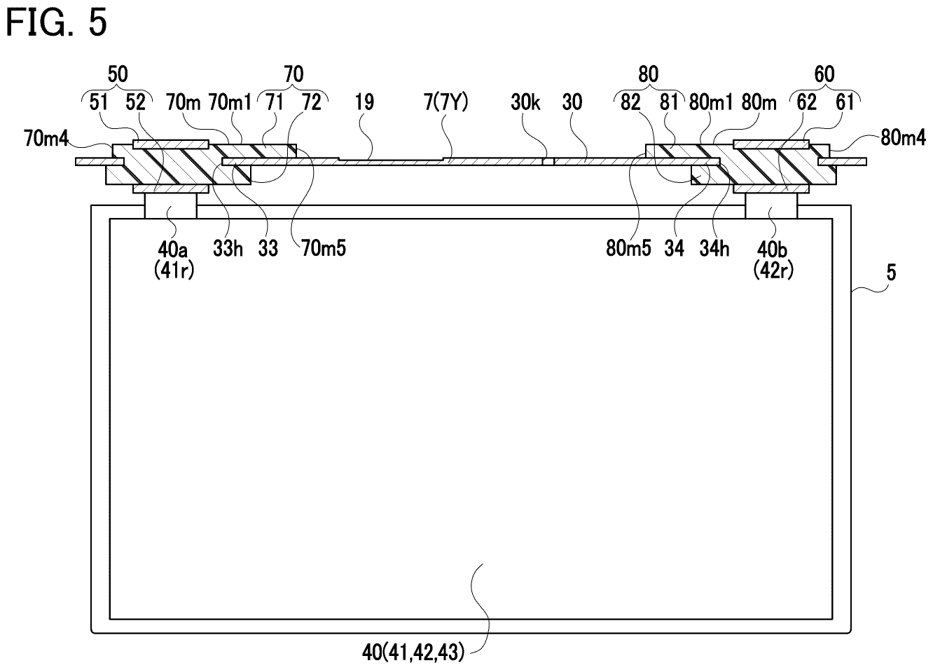

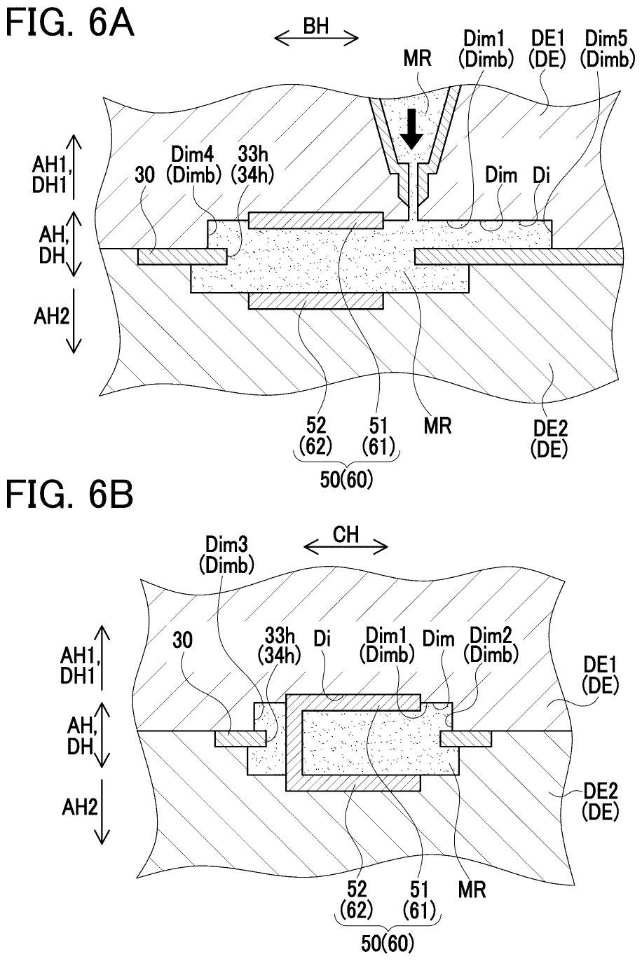

Next, a method for producing the battery 1 configured as above will be described (see FIGS. 4 to 8B). First, in a lid assembly forming step S1 (see FIG. 4), a lid assembly 7 is formed (see FIGS. 5, 6A, and 6B). That is, the lid 30 and the terminal members 50 and 60 are prepared, and the resin members 70 and 80 are formed by insert-molding to integrate the terminal members 50 and 60 with the lid 30 via the resin members 70 and 80 respectively. Specifically, the lid 30 is produced from an aluminum plate by press working, simultaneously forming the liquid inlet 30k, the insertion holes 33h and 34h, and the safety valve 19. In addition, the positive terminal member 50 is produced from an aluminum plate by press working, and the negative terminal member 60 is produced from a copper plate by press working.

Then, in a mold DE having an upper mold DE1 and a lower mold DE2, the lid 30 is placed first at a predetermined position in the lower mold DE2 (see FIGS. 6A and 6B). Subsequently, the terminal members 50 and 60 are respectively inserted into the insertion holes 33h and 34h of the lid 30 placed in the lower mold DE2. Then, the upper mold DE1 is placed over the lower mold DE2, closing the mold DE. Subsequently, molten resin MR is injected into the mold DE and then cooled to mold the resin members 70 and 80. Then, the upper mold DE1 is moved upward, and a composite molded article 7Y in which the lid integrated with the terminal members 50 and 60 via the resin members 70 and 80 is taken out from the lower mold DE2.

In this insert-molding, the outer surfaces 70m and 80m of the resin members 70 and 80 are each formed by a part (i.e., a surface-forming face Dim) of an inner surface Di of the upper mold DE1. Specifically, the first outer surfaces 70m1 and 80m1 of the outer surfaces 70m and 80m of the resin members 70 and 80 are each formed by a first surface-forming face Dim 1 (see FIGS. 6A and 6B) of the surface-forming face Dim of the upper mold DE1. The second outer surfaces 70m2 and 80m2 of the outer surfaces 70m and 80m are each formed by a second surface-forming face Dim2 (see FIG. 6B) of the surface-forming face Dim. The third outer surfaces 70m3 and 80m3 of the outer surfaces 70m and 80m are each formed by a third surface-forming face Dim3 (see FIG. 6B) of the surface-forming face Dim. The fourth outer surfaces 70m4 and 80m4 of the outer surfaces 70m and 80m are each formed by a fourth surface-forming face Dim4 (see FIG. 6A) of the surface-forming face Dim. The fifth outer surfaces 70m5 and 80m5 of the outer surfaces 70m and 80m are each formed by a fifth surface-forming face Dim5 (see FIG. 6A) of the surface-forming face Dim. In the present embodiment, the entire surface-forming face Dim of the upper mold DE1 (i.e., the first surface-forming face Dim1, the second surface-forming face Dim2, the third surface-forming face Dim3, the fourth surface-forming face Dim4, and the fifth surface-forming face Dim5) is a smoothed-region forming face Dimb for forming each smoothed region FM described later.

In the present embodiment, the entire inner surface Di of the upper mold DE1 is mirror-finished, so that the entire surface-forming face Dim (i.e., the smoothed-region forming face Dimb) is mirror-finished. Accordingly, the entire outer surfaces 70m and 80m of the resin members 70 and 80 which are formed by the surface-forming face Dim of the upper mold DE1 (i.e., the first outer surfaces 70m1 and 80m1, the second outer surfaces 70m2 and 80m2, the third outer surfaces 70m3 and 80m3, the fourth outer surfaces 70m4 and 80m4, and the fifth outer surfaces 70m5 and 80m5) are each the smoothed region FM having a surface roughness Ra of 0.6 μm or less (specifically, 0.1 μm).

Then, the electrode body 40 formed by stacking the positive electrode plates 41, the negative electrode plates 42, and the separators 43 is prepared, and the inner terminal portions 52 and 62 of the terminal members 50 and 60 of the composite molded article 7Y are welded and connected to the positive electrode tab 40a and the negative electrode tab 40b of the electrode body 40, respectively (see FIG. 5). Further, the electrode body 40 is enclosed in the bag-shaped insulating holder 5. Thus, the lid assembly 7 composed of the lid 30, the terminal members 50 and 60, the resin members 70 and 80, the electrode body 40, and the insulating holder 5 is formed.

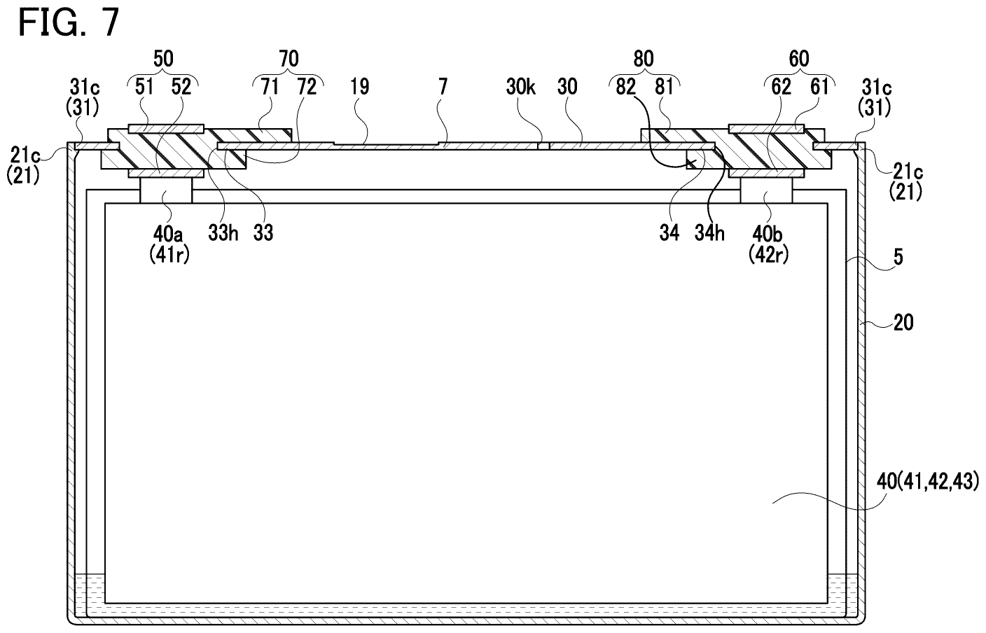

In a closing step S2 (see FIG. 4), the case body 20 is prepared, the electrode body 40, covered with the insulating holder 5, of the lid assembly 7 is inserted into the case body 20, and the opening portion 21 of the case body 20 is closed with the lid 30 (see FIG. 7). Specifically, the lid 30 is placed to close the opening portion 21 of the case body 20 such that the pair of long-side peripheral portions 31b of the peripheral portion 31 of the lid 30 faces the pair of long-side opening portions 21b of the opening portion 21 of the case body 20, and the pair of short-side peripheral portions 31c of the peripheral portion 31 of the lid 30 faces the pair of short-side opening portions 21c of the opening portion 21 of the case body 20.

In a welding step S3 (see FIG. 4), laser welding is performed over the entire circumference of the lid 30 by irradiating the laser beam LB onto the opening portion 21 of the case body 20 and the peripheral portion 31 of the lid from above on an outer side DH1 in the lid thickness direction DH of the lid (i.e., the upper side AH1 in the battery height direction AH) to melt and mix the opening portion 21 and the peripheral portion 31 to form a molten metal portion 18Z, and the molten metal portion 18Z is then solidified, forming the melt-solidified portion 18 to complete the case 10 (see FIGS. 8A and 8B).

At this time, the scattered light LC of the laser beam LB, radiated from the irradiated portion P, directly reaches parts of the outer surfaces 70m and 80m of the resin members 70 and 80, i.e., the second outer surfaces 70m2 and 80m2, the third outer surfaces 70m3 and 80m3, the fourth outer surfaces 70m4 and 80m4, and the fifth outer surfaces 70m5 and 80m5. If the surface roughnesses Ra of these scattered light-reached surfaces 70ma and 80ma are large, specifically, if each surface roughness Ra is greater than 0.6 μm, the scattered light LC is less likely to be reflected by the scattered light-reached surfaces 70ma and 80ma, and is likely to be absorbed by the resin members 70 and 80, so that a scorched portion BP is likely to be formed on the scattered light-reached surfaces 70ma and 80ma. In particular, the second outer surfaces 70m2 and 80m2 and the third outer surfaces 70m3 and 80m3 of the scattered light-reached surfaces 70ma and 80ma are close to the irradiated portion P for the laser beam LB, and the scattered light LC having high intensity is applied thereto, so that a scorched portion BP is particularly likely to be formed thereon.

In contrast, in the present embodiment, the entire outer surfaces 70m and 80m of the resin members 70 and 80 (i.e., the first outer surfaces 70m1 and 80m1, the second outer surfaces 70m2 and 80m2, the third outer surfaces 70m3 and 80m3, the fourth outer surfaces 70m4 and 80m4, and the fifth outer surfaces 70m5 and 80m5) are each formed as the smoothed region FM having a surface roughness Ra of 0.6 μm or less, specifically, 0.1 μm. Therefore, the scattered light LC of the laser beam LB is likely to be reflected by any part of the outer surfaces 70m and 80m, and is less likely to be absorbed by the resin members 70 and 80, so that any part of the outer surfaces 70m and 80m can prevent formation of the scorched portion BP thereon.

In a liquid injecting and sealing step S4, subsequently, the electrolyte 3 is injected into the case 10 through the liquid inlet 30k so that the electrode body 40 is impregnated therewith. Then, the liquid inlet 30k is covered with the sealing member 39 from the outside, and the sealing member 39 is welded to the lid 30 over the entire circumference to hermetically seal between the sealing member 39 and the lid 30.

In an initial charging and aging step S5, a charging device (not shown) is connected to the battery 1 to initially charge the battery 1. Then, this initially charged battery 1 is left to stand for a predetermined time to age the battery 1. Thus, the battery 1 is completed.

The method for producing the battery 1 of the present embodiment uses the lid assembly 7 including the resin members 70 and 80 in which the entire outer surfaces 70m and 80m including the scattered light-reached surfaces 70ma and 80ma are all formed as the smoothed regions FM having a surface roughness Ra of 0.6 μm or less. Accordingly, in the welding step S3, even if the scattered light LC of the laser beam LB directly reaches to any part of the outer surfaces 70m and 80m of the resin members 70 and 80, the scattered light LC is likely to be reflected by the entire outer surfaces 70m and 80m, and is less likely to be absorbed by the resin members 70 and 80. This can prevent formation of a scorched portion BP on any part of the outer surfaces 70m and 80m.

In the present embodiment, in the lid assembly forming step S1, the resin members 70 and 80 in which the entire outer surfaces 70m and 80m are each the smoothed region FM are molded by using the upper mold DE1 in which the entire surface-forming face Dim is mirror-finished. Therefore, at the same time as molding the resin members 70 and 80, the smoothed region FM can be formed over each of the entire outer surfaces 70m and 80m of the resin members 70 and 80.

While the present disclosure has been described above based on the embodiment, it should be understood that the present disclosure is not limited to the embodiment but can be applied with modifications appropriately made thereto without departing from the scope of the gist of the present disclosure.

For example, the foregoing embodiment exemplifies that not only parts of the scattered light-reached surfaces 70ma and 80ma but also the entire outer surfaces 70m and 80m of the resin members 70 and 80 are each formed as the smoothed region FM having a surface roughness Ra of 0.6 μm or less, but the present disclosure is not limited thereto. Only parts of the scattered light-reached surfaces 70ma and 80ma, e.g., only the second outer surfaces 70m2 and 80m2 and the third outer surfaces 70m3 and 80m3, or only the second outer surfaces 70m2 and 80m2, the third outer surfaces 70m3 and 80m3, and the fourth outer surfaces 70m4 and 80m4, may be each formed as the smoothed region FM.

In the embodiment, the laminated electrode body 40 is exemplified as the electrode body housed in the case 10, but the electrode body may be a flat wound electrode body. In a single case, a plurality of electrode bodies may be housed together.

### REFERENCE SIGNS LIST

1 Battery (Power storage device)
7 Lid assembly
7Y Composite molded article
10 Case
18 Melt-solidified portion
20 Case body
21 Opening portion
Lid
31 Peripheral portion
33, 34 Insertion-hole surrounding portion
33h, 34h Insertion hole
Electrode body
50, 60 Terminal member
70, 80 Resin member
70m, 80m Outer surface
70ma, 80ma Scattered light-reached surface
LB Laser beam
LC Scattered light
P Irradiated portion
BP Scorched portion
FM Smoothed region
DE Mold
DE1 Upper mold
Dim Surface-forming face
Dimb Smoothed-region forming face
DE2 Lower mold
51 Lid assembly forming step
S2 Closing step
S3 Welding step
S4 Liquid injecting and sealing step
S5 Initial charging and aging step

What is claimed is:

1. A method for producing a power storage device,
the power storage device including:
a case including a bottomed tube-shaped case body having an opening portion, and a lid that is laser-welded to the case body over an entire circumference and closes the opening portion;
a terminal member inserted in an insertion hole that penetrates through the lid in a lid thickness direction; and
a resin member joined to the terminal member and joined to an insertion-hole surrounding portion of the lid, which surrounds the insertion hole, while insulating between the terminal member and the insertion-hole surrounding portion of the lid,
wherein the method comprises:
closing the opening portion of the case body with the lid of a lid assembly in which the terminal member is integrated with the lid via the resin member; and
laser-welding the opening portion of the case body and a peripheral portion of the lid over the entire circumference to form the case by irradiating a laser beam to the opening portion of the case body and the peripheral portion of the lid, and
wherein the resin member has an outer surface exposed on an outside of the case, the outer surface including a scattered light-reached surface to which scattered light, which is radiated from an irradiated portion applied with the laser beam, of the opening portion of the case body and the peripheral portion of the lid, directly reaches, and at least a part of the scattered light-reached surface including a smoothed region having a surface roughness Ra of 0.6 μm or less.

2. The method for producing the power storage device according to claim 1, further comprising, before closing the opening portion of the case body, forming the lid assembly by insert-molding the resin member in a state where the terminal member is inserted in the insertion hole of the lid,
wherein in forming the lid assembly,
the resin member including the smoothed region is molded by using a mold in which a surface-forming face for forming the outer surface of the resin member includes a smoothed-region forming face for forming the smoothed region, the smoothed-region forming face being mirror-finished.

3. The method for producing the power storage device according to claim 1, wherein the outer surface of the resin member is formed entirely as the smoothed region.

4. The method for producing the power storage device according to claim 3, further comprising, before closing the opening portion of the case body, forming the lid assembly by insert-molding the resin member in a state where the terminal member is inserted in the insertion hole of the lid,
wherein in forming the lid assembly,
the resin member having the outer surface entirely formed as the smoothed region is molded by using a mold in which a surface-forming face for forming the outer surface of the resin member is entirely mirror-finished.

5. A power storage device comprising:
a case including a bottomed tube-shaped case body having an opening portion, and a lid that is laser-welded to the case body over an entire circumference and closes the opening portion;
a terminal member inserted in an insertion hole that penetrates through the lid in a lid thickness direction; and
a resin member joined to the terminal member and joined to an insertion-hole surrounding portion of the lid, which surrounds the insertion hole, while insulating between the terminal member and the insertion-hole surrounding portion of the lid,
wherein the resin member has an outer surface exposed on an outside of the case, the outer surface including a scattered light-reached surface to which scattered light, which is radiated from an irradiated portion applied with the laser beam, of the opening portion of the case body and the peripheral portion of the lid, directly reaches, and at least a part of the scattered light-reached surface including a smoothed region having a surface roughness Ra of 0.6 μm or less.

6. The power storage device according to claim 5, wherein the outer surface of the resin member entirely includes the smoothed region.
